(19) United States
(12) Patent Application Publication
(10) Pub. No.: US 2005/0238014 A1
(43) Pub. Date: Oct. 27, 2005

(54) Receiver and method for receiving burst mode packet

(76) Inventor: Sungsoo Kang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/983,293

(22) Filed: Nov. 4, 2004

(30) Foreign Application Priority Data
Apr. 22, 2004 (KR) 2004-27774

(51) Int. Cl. H04L 12/56

(52) U.S. Cl. 370/389

(57) ABSTRACT

Provided are a receiver and method for receiving a burst mode packet. The receiver includes a receiver for receiving a burst most packet, the receiver comprising a burst mode packet signal detector detecting a received burst mode packet signal, a burst mode packet signal amplification unit amplifying the detected burst mode packet signal, a feedback amplification unit amplifying an inverted output signal and a non-inverted output signal of the burst mode packet signal amplification unit using a negative feedback method, a differential amplification unit amplifying a differential signal between the inverted output signal and the non-inverted output signal of the feedback amplification unit, and an AC coupling unit performing AC coupling on an output signal output from the differential amplification unit. The receiver may further include a pulse shaping unit which reproduces a wave form of the detected burst mode packet signal.

### BACKGROUND OF THE INVENTION

This application claims the priority of Korean Patent Application No. 2004-27774, filed on Apr. 22, 2004, in the Korean Intellectual Property Office, the disclosure of which is incorporated herein in its entirety by reference.

1. Field of the Invention

The present invention relates to a receiver and method for receiving a high-speed burst mode packet.

2. Description of the Related Art

A conventional optical transmission network allows a lot of data to be transmitted at a high speed using a point-to-point method such as a Synchronous Optical NETwork/Synchronous Digital Hierarchy (SONET/SDH) method. That is, the conventional optical transmission network includes a single link between a transmitter and a receiver. A network adopting a Wavelength Division Multiplex (WDM) method that uses a plurality of wavelengths also includes a single link between a transmitter and a receiver. In general, such conventional optical receivers use AC coupling.

AC coupling shows very idealistic operating characteristics in processing data received at a high speed in real time. However, during AC coupling, use of a coupling capacitor causes base line wander problems to occur when a long string of information is repeatedly included in a sequence of data bits. For example, the long string of information may be “ . . . 011111010 . . . ” that includes a sequence of 1's or 0's.

Also, use of a point-to-multi point network such as a Passive Optical Network (PON) that has an upward channel using Time Division Multiple Access (TDMA) results in a large difference in power between an incoming packet and the next incoming packet. Thus, a threshold required to determine whether an input sequence of bits is at a logical “1” or “0” must be reset whenever a packet is received. However, resetting of the threshold may results in a loss of received bits of information.

To solve this problem, various methods are introduced. In this regard, DC coupling using a peak detector, a high-speed electronic component, and multiple feedback circuits is introduced in an article entitled “Burst-Mode Compatible Optical Receiver With A Large Dynamic Range” [IEEE Journal of Lightwave Tech., VOL. 8, No. 12, pp 1897-1903, December, 1990].

It is highly probable that a burst mode packet experiences a loss of bits of information when fluctuation of power for packets is critical. To solve this problem, U.S. Pat. No. 5,025,456 introduces an automatic threshold adjust circuit using a differential amplifier.

U.S. Pat. No. 5,838,731 discloses a method of converting a unipolar signal into a bipolar signal and enforcedly resetting a previous threshold to an initial value after receipt of packets. U.S. Pat. No. 5,801,867 discloses a method of adjusting a reference value using an input feedback loop, an output feedback loop, and a plurality of sampling and holding circuits.

U.S. Pat. No. 5,875,050 introduces a circuit that is a combination of a tracking pre-amplifier and an Automatic Threshold controller (ATC). For peak detection, U.S. Pat. No. 6,115,163 suggests a method of memorizing a threshold value and a reference level whenever a packet is received, using a circuit that is a combination of an ATC, an Automatic Gain Control (AGC), and a memory.

U.S. Pat. No. 6,191,879 B1 discloses an average detector, a peak detector, and an Automatic DC Offset Controller (AOC) that causes forced discharging after receipt of packets. U.S. Pat. No. 6,362,911 B1 discloses a method of dividing an input optical signal into two signals using a coupler and determining a reference value using an output of an amplifier with a low bandwidth, selected from two amplifiers with different bandwidths.

However, the above methods are difficult to be performed since they require high-speed electronic components and have complicated circuit structures.

To solve DC coupling problems, AC coupling is suggested in an article entitled “Burst-mode differential receiver for optical packet communication” [Electronics Letters, Vol. 32, No. 16, pp. 1500-1501, August 1996]. However, in this case, line code of a data packet is limited to Manchester code, thus causing a need for an increase in a transmission bandwidth and elements operating at a high speed.

U.S. Pat. No. 5,737,366 discloses a method of dividing an input optical signal into two signals using a splitter, making an amplifier using a delay element and a differential feedback circuit with respect to one of the two signals, using a delay element and a differential feedback circuit, making an amplifier that uses a feedback signal with respect to the other signal of the two signals, amplifying a differential signal of the two signals using a differential amplifier to obtain a differential bipolar signal, and inputting the differential bipolar signal into a D-type Flip/Flop to obtain the original data signal.

This method allows AC coupling to be applied to a burst mode packet transmitted using None-Return-to-Zero (NRZ) code that is generally preferred. However, this method is disadvantageous in that it is difficult to make circuits since this method requires two optical receivers and a splitter, and a high-speed analog differential amplifier is further required.

U.S. Pat. No. 6,420,928 B1 introduces a method of receiving data in a burst mode using AC coupling. In this method, an edge where a bit of data is changed, e.g., from a logical “1” to a logical “0” or from a logical “0” to a logical “1”, is defined as a driver edge, an edge where a bit of data is not changed is defined as a non-driver edge, and a time constant of the non-driver edge is set to be greater that of the driver edge but is smaller than an Inter Packet Gap (IPG).

However, this method requires installation of a differential amplifier and a filter, to which a positive feedback is given, after a Trans-impedance Amplifier (TIA) used in an optical receiver, and a comparator operating according to a positive feedback method. Therefore, these elements have complicated circuit constitutions and are not easy to implement so as to receive a signal at a high operating speed of 10 Gb or more.

### SUMMARY OF THE INVENTION

The present invention provides a receiver and method for receiving a burst mode packet while minimizing a loss of bits of information in even when there is a critical fluctuation in power between burst mode packets received at a high speed, and a method of receiving the same.

According to an aspect of the present invention, there is provided a receiver for receiving a burst mode packet, the receiver comprising a burst mode packet signal detector detecting a received burst mode packet signal, a burst mode packet signal amplification unit amplifying the detected burst mode packet signal, a feedback amplification unit amplifying an inverted output signal and a non-inverted output signal of the burst mode packet signal amplification unit using a negative feedback method, a differential amplification unit amplifying a differential signal between the inverted output signal and the non-inverted output signal of the feedback amplification unit, and an AC coupling unit performing AC coupling on an output signal output from the differential amplification unit.

The receiver may further include a pulse shaping unit which reproduces a wave form of the detected burst mode packet signal.

According to another aspect of the present invention, there is provided a method of receiving a burst mode packet, the method including detecting a received burst mode packet signal, amplifying the burst mode packet signal, amplifying an inverted output and non-inverted output of the amplified burst mode packet signal using a negative feedback method, amplifying a differential signal between the amplified inverted output and non-inverted output, and performing AC coupling on the amplified differential signal.

The method may further include reproducing a pulse of the detected burst mode packet signal.

### BRIEF DESCRIPTION OF THE DRAWINGS

The above and other aspects and advantages of the present invention will become more apparent by describing in detail exemplary embodiments thereof with reference to the attached drawings in which:

FIG. 1 illustrates burst mode packets incoming to a general packet receiver;

FIG. 2A is a circuit diagram of a receiver for receiving a burst mode packet according to an embodiment of the present invention;

FIG. 2B is a flowchart illustrating a method of receiving a burst mode packet according to an embodiment of the present invention;

FIG. 2C is a diagram illustrating the waveforms of a signal containing a sequence of data bits incoming to the receiver of FIG. 2A, viewed at several output terminals of the receiver;

FIG. 2D is a circuit diagram of a pulse shaping unit according to an embodiment of the present invention; and

FIG. 2E is a diagram illustrating the waveforms of a signal containing a sequence of data bits incoming to the pulse shaping unit of FIG. 2C, viewed at several output terminals of the pulse shaping unit.

### DETAILED DESCRIPTION OF THE INVENTION

For better understanding of the present invention, a receiver for receiving a burst mode packet according to the present invention will be described briefly. The receiver is fabricated by connecting a Trans-Impedance Amplifier (TIA), a differential feedback circuit, and a differential amplifier, and performs AC coupling using a capacitor. For reproduction of a pulse, a pulse shaping unit may further be installed in the receiver.

Use of a differential feedback amplifier that is robust to common-mode disturbance allows an improved output to be obtained and even-order distortion to be canceled, disclosed in articles entitled “Simulation of Return Ratio in Fully Differential Feedback Circuits” [IEEE 1994 Custom Integrated Circuits Conference, pp. 29-32, August 1994] and “An Approach to Fully Differential Circuits Design without Common-Mode Feedback” [IEEE Trans. on Circuits and Systems-II: Analog and Digital Signal Processing, Vol. 43, No. 11, pp. 752-762, November 1996]. common-mode disturbance.

According to the present invention, based on such characteristics of the differential feedback amplifier, the TIA is installed in an opto-electric converter of a general optical receiver and the differential feedback amplifier is connected to the TIA.

Hereinafter, exemplary embodiments of the present invention will be described in detail with reference the accompanying drawings. The same reference numerals represent the same elements throughout the drawings.

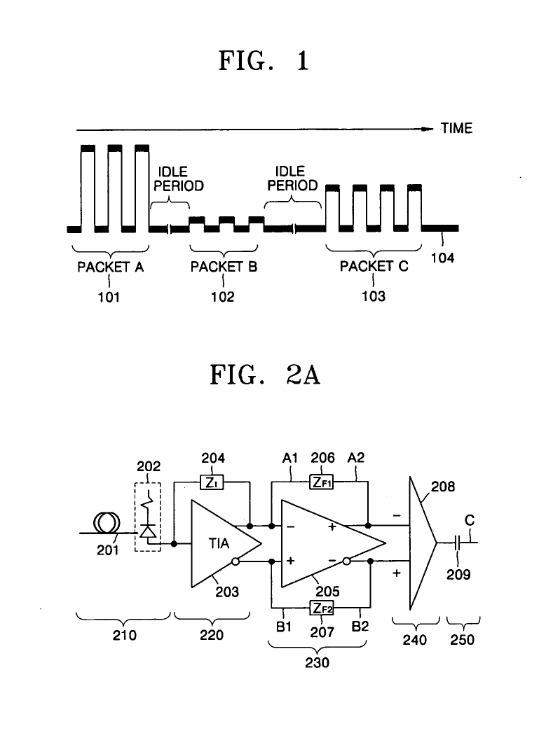

FIG. 1 illustrates burst mode packets incoming to a general packet receiver. In FIG. 1, a packet A 101, a packet B 102, and a packet C 103 are data packets transmitted from different transmitters (not shown).

Since the distances between the respective transmitters and a receiver (not shown) are different from one another, the power amplitude of signals of the packets A 101 through C 103 received by the receiver are remarkably different from one another as shown in FIG. 1. Also, referring to FIG. 1, the distances, i.e., idle periods, between the packets A 101 and B 102 and between the packets B 102 and C 103, i.e., the lengths of time during which packet data is not transmitted, are not uniform. In FIG. 1, a reference numeral 104 denotes noise generated during the idle period, marked by thick lines. As shown in FIG. 1, the noise is generated and overlaps with a packet signal even when receiving the packets A 101 through C 103.

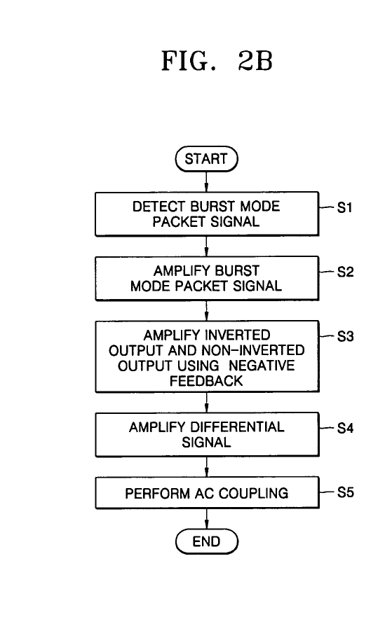

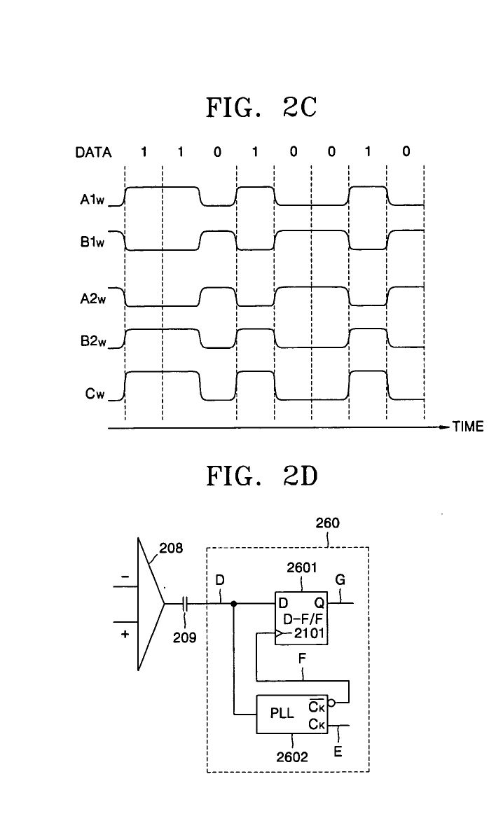

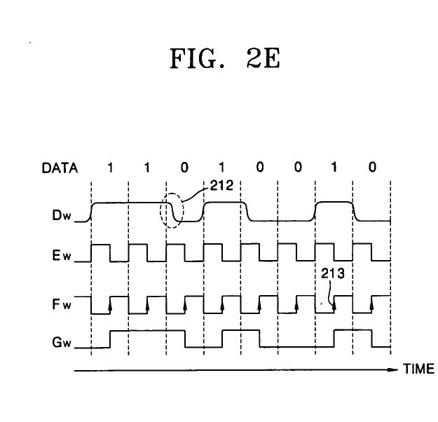

FIG. 2A is a circuit diagram of a receiver for receiving a burst mode packet according to an embodiment of the present invention. FIG. 2B is a flowchart illustrating a method of receiving a burst mode packet according to an embodiment of the present invention. The receiver includes a burst mode packet signal detector 210, a burst mode packet signal amplifier 220, a differential feedback amplification unit 230, a differential amplification unit 240, and an AC coupling unit 250.

The burst mode packet signal detector 210 includes an optical fiber 201 and an opto-electronic converter 202. When an optical burst mode packet signal transmitted from a transmitter (not shown) via the optical fiber 201 is input to the opto-electric converter 202, this signal is transformed into an electrical signal and the electric signal is output (S1). The optical fiber 201 is a transmission medium used in the point-to-multi-point communication. The opto-electric converter 202 is fabricated with filter resistors for a photo diode and a bias. The filter resistors may be installed in the TIA 203.

The receiver of FIG. 2A is manufactured to include the optical fiber 201 and the opto-electric converter 202 to use a Passive Optical Network (PON) that allows transmission of burst mode packets via an optical fiber. However, the present invention is not limited to the above description. If burst mode packets are transmitted by wireless, a transmission medium and a converter suitable to wireless data transmission are used.

The burst mode packet signal amplifier 220 amplifies the output electrical signal (S2). The burst mode packet signal amplifier 220 includes the TIA 203 with a differential output, and a feedback element Zₜ 204.

The differential feedback amplification unit 230 amplifies a differential signal between output from an inverting output terminal A1 and a non-inverting output terminal B1 of the TIA 203 (S3). The differential feedback amplification unit 230 includes a negative feedback circuit formed by output impedance of the non-inverting output terminal A1 and a feedback element Z_{F1} 206, and a negative feedback circuit formed by output impedance of the non-inverting output terminal B1 of the TIA 203 and a feedback element Z_{F2} 207.

A differential amplifier 208 of the differential amplification unit 240 amplifies a differential signal between a non-inverted output signal and an inverted output signal output from the differential feedback amplification unit 230 (S4). The AC coupling unit 250 performs AC coupling on the amplified differential signal using an AC coupling capacitor 209 (S5) and outputs a signal obtained by amplifying the differential signal between the non-inverted output signal and the inverted output signal output from the differential feedback amplifier 230.

FIG. 2C illustrates the waveforms of a signal containing a sequence of bits of data input to the receiver of FIG. 2A, viewed at the inverted output terminal A1, the non-inverted output terminal B1, and other output terminals A2, B2, and C. More specifically, assuming that a sequence of bits of data, e.g., ‘1010010’, is incoming, A1_{W} denotes the waveform of the signal at the non-inverted output terminal A1 of the TIA 203, B1_{W} denotes the waveform of the signal at the inverted output terminal of the TIA 203, A2_{W} denotes the waveform of the signal at the inverted output terminal A2 of the differential feedback amplification unit 230, and B2_{W} denotes the waveform of the signal at the non-inverted output terminal B2 of the differential feedback amplification unit 230. C_{W} denotes the waveform of a signal (hereinafter, “output signal”) obtained when inputting a differential signal between A2 and B2 of the differential feedback amplification unit 230 to the differential amplifier 208 and the AC coupling capacitor 209.

FIG. 2D is a circuit diagram of a pulse shaping unit 260 according to an embodiment of the present invention. FIG. 2E illustrates the waveforms of a signal input to the pulse shaping unit 260 of FIG. 2D, viewed at output terminals D, E, F, and G thereof. In FIG. 2E, D_{w} denotes the waveform of the signal at the output terminal D of the AC coupling capacitor 209, E_{W} denotes the waveform of the signal at the clock output terminal E of the PLL 2602, F_{W} denotes the waveform of the signal at the inversion output terminal F of the PLL 2602, and G_{W} denotes the waveform of the signal at the output terminal G of a D-F/F 2601.

Referring to FIGS. 2D and 2E, the pulse shaping unit 260 includes a D-Flip Flop (D-F/F) 2601 and a Phase Locked Loop (PLL) 2602. The PLL 2602 is a general PLL that outputs an operating clock Cₖ of an output signal D_{W} and an inversion of the operating clock Cₖ when the output signal D_{W} is input to the PLL 2602, and outputs its free-running clock otherwise.

Referring to FIG. 2E, the D-F/F 2601 outputs the output signal D_{W} at a rising edge 213 of a clock F_{w} input to the D-F/F 2601 so as to reproduce a packet pulse signal input to a receiver (not shown). The reproduction of the packet pulse signal is required to equalize the sizes of the signal, which is transmitted from the AC coupling capacitor 209, at a logical “1” and a logical “0” on a time axis when the waveform of the signal is equivalent to the waveform D_{w} of FIG. 2E rather than the waveform C_{w} of FIG. 2C (see reference numeral 212 of FIG. 2E), caused by threshold unbalance or hysteresis occurring in the differential feedback amplification unit 230 and the differential amplifier 208 of FIG. 2A. That is, the reproduction of the packet pulse signal allows a signal transmitted from the transmitter to be precisely reproduced in the receiver when the sizes of the signal at the logical “1” and the logical “0” are not the same.

Referring to FIG. 2D, when a signal that contains a sequence of bits of data, e.g., 11010010, output from the AC coupling capacitor 209, is input to the output terminal D, the PLL 2602 outputs the clock Ewsynchronized with a clock of the data and an inverted clock F_{W} of the clock E_{W}. The inverted clock F_{W} is input to an operating clock input terminal 2101 of the D-F/F 2601, which operates at a rising edge of clock, a signal with the waveform D_{W} of FIG. 2E is transmitted to an output terminal G of the D-F/F 2601 at rising edges of the inverted clock F_{W}, thus producing a signal with the waveform G_{W}. The signal with the waveform G_{W} is a reproduction signal of the packet pulse signal received by the receiver. As shown in FIG. 2E, the waveform G_{W} is obtained by delaying D_{W} by half a clock cycle. That is, it is possible to equalize the sizes of signal at logical “1” and logical “0” on a time axis by delaying D_{W}.

The present invention can be embodied as a computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable recording medium can be distributed among computer systems that are interconnected through a network, and the present invention may be stored and implemented as a computer readable code in the distributed system.

The present invention provides a method and apparatus for receiving burst mode packets while minimizing a loss of bits of data even when power fluctuation is critical when receiving the burst mode packets at a high speed. The apparatus and method are easy to be embodied, and AC coupling is applicable to the method and apparatus. Also, the method and apparatus are advantageous in that they just require the bandwidths of a differential feedback amplifier, and a differential amplifier to match the speed at which a data packet is received.

In the present invention, Trans-Impedance Amplifier (TIA) is fabricated to have a differential feedback circuit constitution to which a differential amplifier is connected, and AC coupling structure is connected to the differential amplifier. Therefore, the present invention provides the advantage of constituting simple structure for high-speed performance. Use of a Phase Locked Loop (PLL), which is used by other types of receivers, allows reproduction of a wave form resembling a sequence of bits of data of a received burst mode packet.

While this invention has been particularly shown and described with reference to exemplary embodiments thereof, it will be understood by those skilled in the art that various changes in form and details may be made therein without departing from the spirit and scope of the invention as defined by the appended claims.

1. A receiver for receiving a burst most packet, comprising:
a burst mode packet signal detector detecting a received burst mode packet signal;
a burst mode packet signal amplification unit amplifying the detected burst mode packet signal;
a feedback amplification unit amplifying an inverted output signal and a non-inverted output signal of the burst mode packet signal amplification unit using a negative feedback method;
a differential amplification unit amplifying a differential signal between the inverted output signal and the non-inverted output signal of the feedback amplification unit; and
an AC coupling unit performing AC coupling on an output signal output from the differential amplification unit.

2. The receiver of claim 1, further comprising a pulse shaping unit which reproduces a wave form of the detected burst mode packet signal.

3. The receiver of claim 1, wherein the burst mode packet signal detector comprises:
an optical fiber; and
an opto-electric converter,
wherein the opto-electric converter comprises:
a photo diode; and
a filter resistor for a bias.

4. The receiver of claim 1, wherein the burst mode packet signal amplification unit comprises:
a trans-impedance amplifier outputting a differential output; and
a feedback element Zₜ which negatively feedbacks output signal of the trans-impedance amplifier.

5. The receiver of claim 3, wherein the filter resistor for a bias is installed in the trans-impedance amplifier of the burst mode packet signal amplification unit.

6. The receiver of claim 1, wherein the feedback amplification unit comprises:
a first negative feedback circuit formed by output impedance of a non-inverted output terminal of the trans-impedance amplifier and a feedback element Z_{F1}; and
a second negative feedback circuit formed by output impedance of an inverted output terminal of the trans-impedance amplifier and a feedback element Z_{F2}.

7. The receiver of claim 1, wherein the AC coupling unit performs AC coupling on the output signal by connecting an AC coupling capacitor to an output terminal of the differential amplification unit.

8. The receiver of claim 2, wherein the pulse shaping unit comprises:
a phase locked loop receiving the output signal and outputting an operating clock of the output signal and an inverted clock of the operating clock; and
a D-Flip Flop receiving the output signal and outputting the output signal only at rising edges of the inverted clock to reproduce a wave form of the burst mode packet signal.

9. A method of receiving a burst mode packet, comprising:
detecting a received burst mode packet signal;
amplifying the burst mode packet signal;
amplifying an inverted output and non-inverted output of the amplified burst mode packet signal using a negative feedback method;
amplifying a differential signal between the amplified inverted output and non-inverted output; and
performing AC coupling on the amplified differential signal.

10. The method of claim 9, further comprising reproducing a pulse of the detected burst mode packet signal.
